(19) United States
(12) Patent Application Publication
(10) Pub. No.: US 2004/0203936 A1
(43) Pub. Date: Oct. 14, 2004

(54) Communication terminal, communication system, and computer program product

(76) Inventors: Minoru Ogino, Kawasaki-shi (JP); Yukihiro Yamada, Irima-gun (JP); Katsunori Yamamoto, Yachiyo-shi (JP); Toshiaki Fujikura, Urayasu-shi (JP)

Correspondence Address: MCDERMOTT WILL & EMERY LLP, 600 13TH STREET, N.W., WASHINGTON, DC, 20005-3096, US

(21) Appl. No.: 10/274,452

(22) Filed: Oct. 21, 2002

(30) Foreign Application Priority Data
Jun. 27, 2002 (JP) 2002-188625

(51) Int. Cl. H04Q 7/20; H04M 1/00; H04B 1/38

(52) U.S. Cl. 455/463; 455/462; 455/553.1

(57) ABSTRACT

It is the objective of the present invention to realize a highly flexible communication system, in which a communication terminal can freely change from master station operating mode to slave station operating mode or vice versa at its own spontaneous request. In order to achieve this objective, a communication terminal of the present invention, by switching from one mode to the other, operates in either master station operating mode for communicating with a plurality of slave stations that constitute a communication system, and also for controlling the communication system, or slave station operating mode for operating as a slave station in response to a control message from a master station. When terminal 2 operating in slave station operating mode needs to operate as the master station, terminal 2 informs terminal 5, which is the master station, of a transition request REQ 1, for making the transition to the master station. Terminal 5 sends a transition permission signal ANS 1, to terminal 2, and then terminal 2 makes the transition from the slave station to the master station.

### BACKGROUND OF THE INVENTION

1. Field of the Invention

The present invention relates to a communication system, or more particularly, to a communication system in which it is possible to freely change the setting of either a master station operating mode or a slave station operating mode.

2. Description of the Related Art

Conventional communication systems such as a wireless LAN system, in which plural wireless terminals communicate with each other, can be classified into peer to peer type, centralized type and hybrid type. The peer to peer type is the type in which all wireless terminals communicate with each other on a peer-to-peer basis. The centralized type is the type in which a base station controls communication with the mobile stations. The hybrid type is the type in which a base station controls communication, while all terminals including the base station, communicate with each other on a peer-to-peer basis. The optimum system designing is conducted by referring to use patterns of communication systems to decide which system type to be adopted.

However, since a master station is previously fixed in the system of the conventional centralized type, slave stations have to communicate with each other through the master station, or by using a separately prepared communication control protocol. Therefore, the system control lacks flexibility and has poor versatility. Furthermore, when plural systems are controlled by means of time division multiplexing using multislots, the communication quality deteriorates due to the effect of high bit rate communication. Therefore, it is necessary to smoothly control a complicated communication system by using a simple protocol without causing the communication quality to deteriorate.

Accordingly, it is the objective of the present invention to provide a communication terminal, a communication system, and a computer program product, which can realize flexible system designing by making it possible to freely change a master station in accordance with a request from an application and a program, without previously setting any distinction between a master station and a slave station.

### SUMMARY OF THE INVENTION

In order to achieve the above objective, a communication terminal of the present invention operates in either master station operating mode for communicating with a plurality of slave stations that constitute a communication system, and also for controlling the communication system, or slave station operating mode for operating as a slave station in response to a control message from a master station, by switching from one mode to the other. The communication terminal of the present invention has a transition request means for informing the master station of a transition request for its transition from the slave station to the master station, when it becomes necessary to perform as the master station while it is operating in the slave station operating mode, and it also has a mode switching means for making the transition from slave station operating mode to master station operating mode, when receiving a transition permission signal from the master station.

It is preferable that any communication terminal in master station operating mode is able to be selected as a slave station.

It is also preferable for the mode switching means to automatically switch from slave station operating mode to master station operating mode when it does not receive a transition permission signal from a master station, even after a predetermined period of time has elapsed since informing the master station of the transition request.

It is preferable that at a predetermined time, when a communication terminal in master station operating mode checks by carrier-sensing, whether or not another master station exists on the same channel, and if it detects the existence of another master station, the terminal switches to the slave station.

Preferably, by switching from one mode to the other, the communication terminal of the present invention operates in either master station operating mode for communicating with a plurality of slave stations that constitute a communication system, and also for controlling the communication system, or slave station operating mode for operating as a slave station in response to a control message from a master station. The communication terminal of the present invention, includes a permission signal sending means for sending a permission signal to another communication terminal when operating in the master station operating mode, receiving a transition request from another communication terminal for making the transition from the slave station to the master station, and a mode switching means for making the transition from master station operating mode to slave station operating mode after sending the permission signal.

It is preferable that the communication terminal of the present invention further include a standby mode, in which if no master station is selected within a communication system, the terminal operates as neither the master station nor the slave station.

It is preferable that in the standby mode, system synchronization is established by means of heart beats between the communication terminals that constitute the communication system.

It is preferable that if the communication terminal in the standby mode is to make the transition to the master station, it makes the transition to the master station after carrier-sensing for a predetermined period of time, in order to confirm that there is no master station on the same channel.

By switching from one mode to the other, the communication system of the present invention comprises a plurality of communication terminals operating in either master station operating mode for communicating with a plurality of slave stations that constitute the communication system, and also for controlling the communication system, or slave station operating mode for operating as a slave station in response to a control message from a master station. When the slave station needs to operate as the master station, the slave station operating in slave station operating mode informs the master station of a transition request to make the transition to the master station, and when receiving the transition request, the master station sending a transition permission signal to permit the transition request to make the transition to the master station, and the slave station receiving the transition permission signal from the master station, switches from slave station operating mode to master station operating mode.

A computer program product of the present invention cause a communication terminal to switch, when necessary, between master station operating mode for communicating with a plurality of slave stations that constitute a communication system, and also for controlling the communication system, and slave station operating mode for operating as a slave station in response to a control message from a master station. The program makes the communication terminal carry out the steps of: when the slave station operating in slave station operating mode needs to operate as the master station, it informs the master station of a transition request for making the transition from the slave station to the master station; and switching from slave station operating mode to master station operating mode when receiving a transition permission signal from the master station.

A computer program product of the present invention cause a communication terminal to switch, when necessary, between master station operating mode for communicating with a plurality of slave stations that constitute a communication system, and also for controlling the communication system, and slave station operating mode for operating as a slave station in response to a control message from a master station. The program makes the communication terminal carry out the steps of: sending a permission signal to another communication terminal when the communication terminal operating in the master station operating mode receives from another communication terminal, a transition request for making the transition to the master station; and switching from master station operating mode to slave station operating mode after sending the permission signal.

Examples of computer readable recording mediums for recording the program of the present invention include: optical recording mediums (recording mediums capable of optically reading data, such as CD-RAMs, CD-ROMs, DVD-RAMs, DVD-ROMs, DVD-Rs, PD discs, MD discs and MO discs); magnetic recording mediums (recording mediums capable of magnetically reading data, such as flexible discs, magnetic cards, and magnetic tapes); or memory devices (semiconductor memory devices like DRAMs and ferroelectric memory devices like FRAMs).

### BRIEF DESCRIPTION OF THE DRAWINGS

FIG. 1 is a timing chart representing heart beat synchronization among wireless terminals.

FIG. 2 is a timing chart representing transition to the master station.

FIG. 3 is a timing chart representing master transmission and slave reception.

FIG. 4 is a mode switching transition sequence.

FIG. 5 is a mode switching transition sequence.

FIG. 6 is a block diagram illustrating the wireless terminal of the present invention.

FIG. 7 is an explanatory drawing illustrating the master station operating mode and the slave station operating mode.

FIG. 8 is an explanatory drawing illustrating the master station operating mode and the slave station operating mode.

FIG. 9 is an explanatory drawing illustrating the master station operating mode and the slave station operating mode.

FIG. 10 is an explanatory drawing illustrating the master station operating mode and the slave station operating mode.

FIG. 11 is an explanatory drawing illustrating the master station operating mode and the slave station operating mode.

### DESCRIPTION OF THE PREFERRED EMBODIMENTS

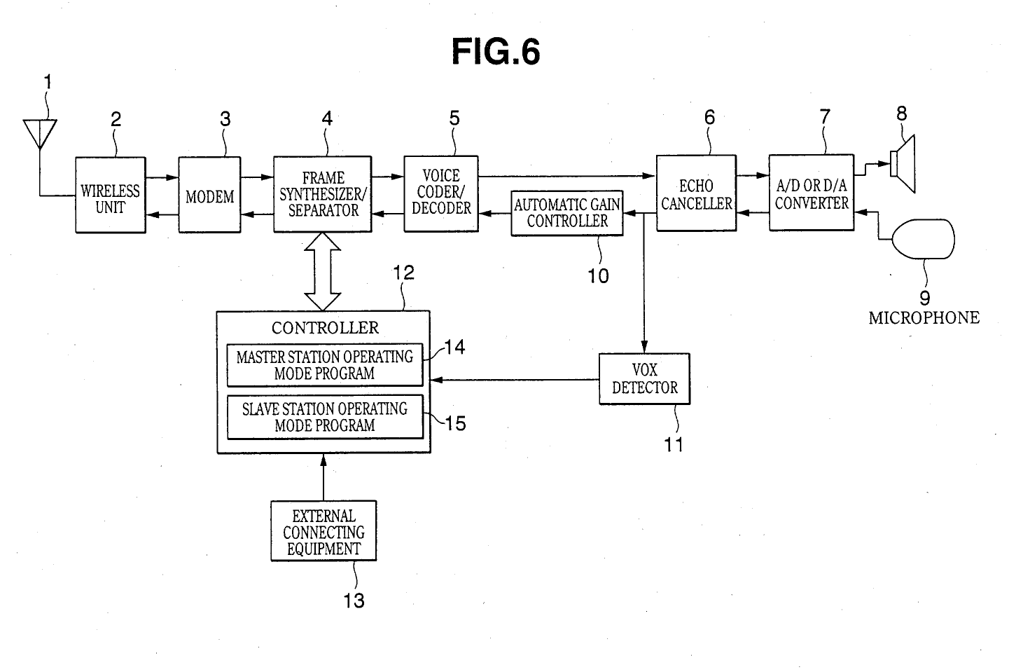

Embodiments of the present invention are hereinafter described with reference to each of the attached drawings. The embodiments will be described by showing an example of a communication system formed by plural wireless terminals such as digital transceivers. FIG. 6 is a block diagram illustrating a wireless terminal of the present invention.

Referring to FIG. 6, the wireless terminal has an antenna 1, a wireless unit 2 connected to the antenna 1, a modem 3, a frame synthesizer/separator 4, a voice coder/decoder 5, an echo canceller 6, an A/D or D/A converter 7, a speaker 8, a microphone 9, an automatic gain controller 10, a VOX detector 11, and a controller 12. External connecting equipment 13, such as a personal computer and a GPS device, can be connected to the controller 12. The external connecting equipment 13 is structured so as to be capable of performing data communication with another wireless terminal, through the terminal of the present invention.

The controller 12 stores a program with necessary steps recorded therein to control the system as a master station (master station operating mode program 14), and a program with necessary steps recorded therein to function as a slave station (slave station operating mode program 15), so that the terminal of the present invention can operate either as the master station or the slave station as necessary. These programs also include a sequence of operation steps for making the transition from the slave station to the master station, or from the master station to the slave station (a transition sequence, which will be described later), and the controller 12 not only conducts various processing necessary for the communication control, but also functions as a mode switching means for switching between master station operating mode and slave station operating mode.

According to this embodiment, when the master station exists within the system, each of the other wireless terminals operates as a slave station under the control of the master station. However, if any event takes place in which it becomes necessary for this slave station to control the system as the master station, for example, when transferring data to other terminals, the terminal makes the transition from the slave station to the master station at the time the event occurs. In other words, no master station is previously set, and any wireless terminal can make the transition to the master station at any time. Therefore, when there is no master station within the system, that is, when every terminal is in standby mode, system synchronization is established among the terminals by means of heart beats. System synchronization is not caused by a fixed base station, but each terminal operates as a base station in turn. Therefore, it is possible to cope with, for example, battery depletion or an ever-changing wireless environment.

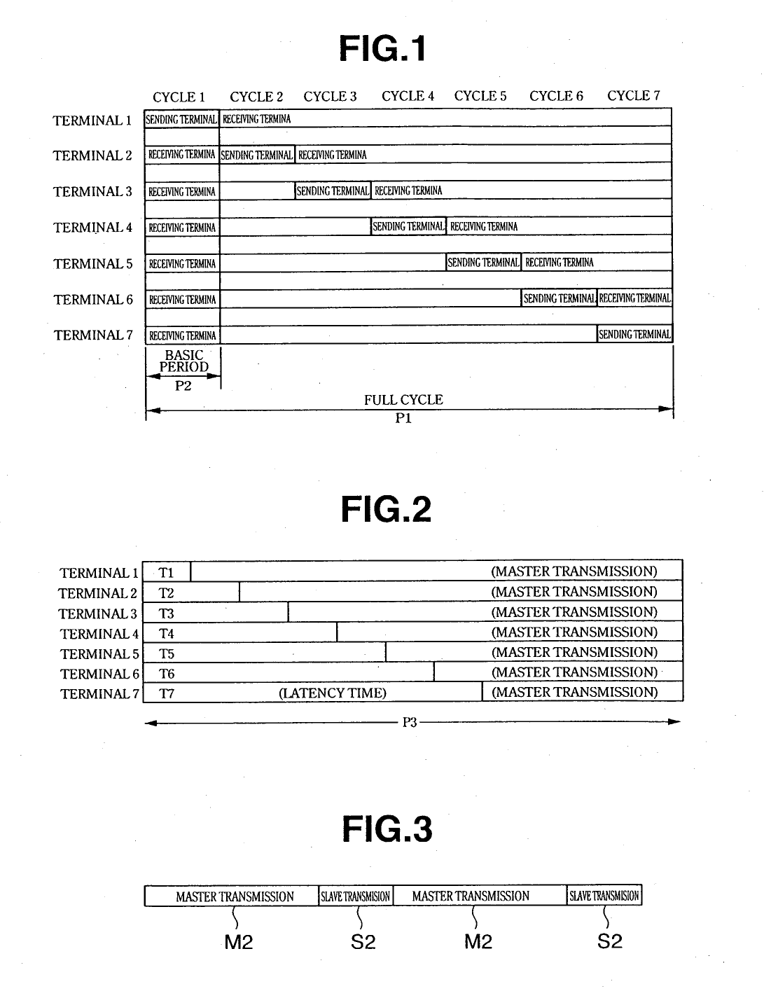

FIG. 1 is a timing chart illustrating the timing of sending and receiving a signal at each terminal in the standby mode. In this drawing, the communication system is assumed to be formed by seven terminals. As shown in FIG. 1, within a full cycle P 1, transition timing is decided for each terminal by setting a basic cycle P 2, and the setting is employed so that the terminal becomes a sending terminal in rotation from terminal 1 to terminal 7. Specifically, in cycle 1, terminal 1 operates as a sending terminal and each of the terminals 2 through 7 operates as a receiving terminal, and in cycle 2, terminal 2 operates as a sending terminal and each of the terminal 1, and terminals 3 through 7, operates as a receiving terminal. Each terminal receives a signal from other terminals in the cycle of operating as the receiving terminal, and makes the transition to the sending terminal in a predetermined cycle.

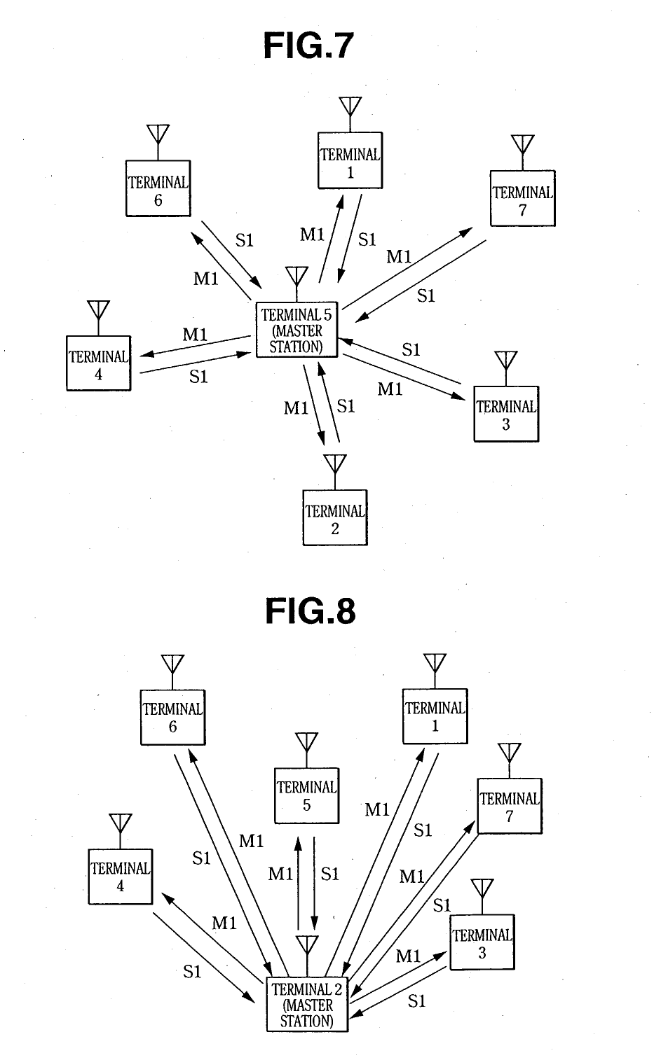

Once the system synchronization is established, any one of the terminals makes the transition to the master station upon the occurrence of any event. Referring to FIG. 7, terminal 5 becomes the master station and controls other terminals. The master station sends a control message M1, including a predetermined frame format, and controls the communication. The control message M1 includes response timing for the slave stations, and each slave station sends a response message S1 at respectively specified timing. If terminal 2 needs to operate as the master station in order to control other terminals, terminal 2 carries out the transition sequence to make the transition to the master station.

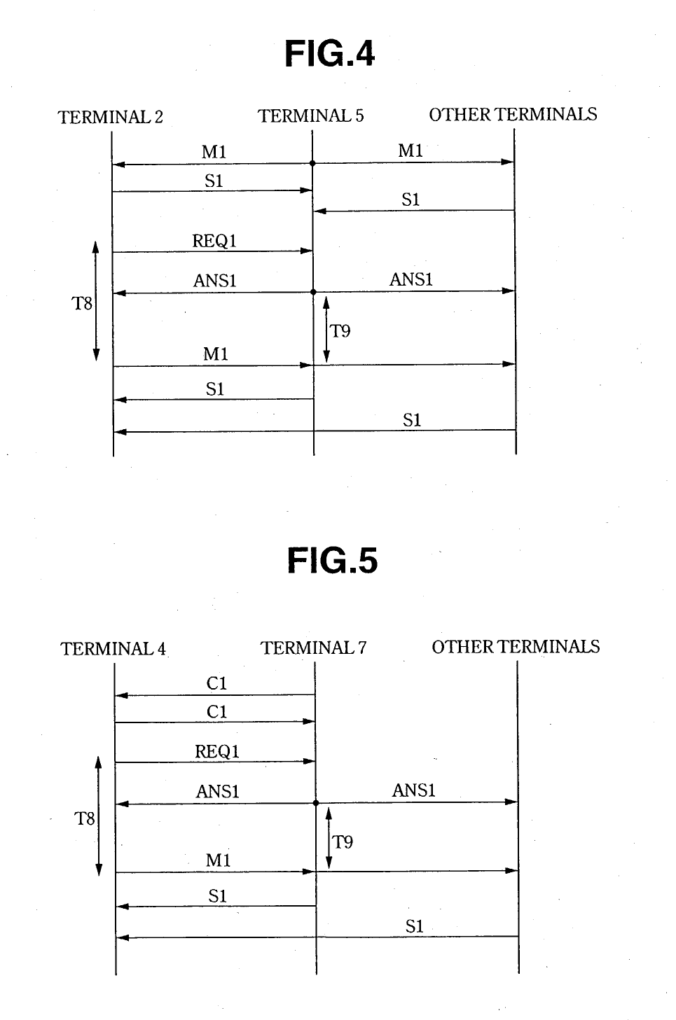

FIG. 4 illustrates the transition sequence in which terminal 2 makes the transition from the slave station to the master station. In this drawing, terminal 5, in its role as the master station, sends the control message M1 to other terminals and receives the response message S1 from each of the other terminals. When terminal 2 needs to operate as the master station because of the occurrence of a certain event, terminal 2 sends a transition request REQ1 to terminal 5 which is the master station at that time. Receiving the REQ1, terminal 5 sends a permission signal ANS1 to all other terminals. All other terminals receiving the permission signal ANS1 can become aware in advance that the master station will be changed. Upon receiving the permission signal ANS1 from terminal 5, terminal 2 makes the transition to the master station. Depending on a wireless environment, it is possible that terminal 2 may not receive the permission signal ANS1. In order to deal with such a situation, terminal 2 also makes the transition to the master station even after a timeout period T8 has elapsed without receiving the permission signal ANS 1. Meanwhile, sending the permission signal ANS1, terminal 5 makes the transition to the slave station after period T9 has elapsed.

When terminal 2 becomes a new master station in accordance with the above transition sequence, the master station sends the control message M1 to the other terminals, and each slave station receiving the control message M1 sends the response message S1 to the master station, thereby completing the transition sequence. FIG. 8 illustrates the state in which the master station makes the transition from terminal 5 to terminal 2, so that terminal 2 controls the system.

Each terminal in standby mode can make the transition to the master station at any time. However, it can be assumed that in some cases, transition timings of plural terminals may conflict with each other. In order to deal with such a situation in this embodiment, at the time of transition to the master station, latency time is set in order to check whether or not another terminal operates as a master station on the same channel. FIG. 2 illustrates the latency time of each terminal. The latency times of the terminals 1 through 7 are set respectively as T1 through T7, in basic cycle P2. The slave station performs carrier-sensing during a predetermined latency period, in order to check whether or not any terminal operates as the master station using the same control channel. Determining that there is no master station, the slave terminal starts to send a signal as a master station after the latency period has elapsed. Each time length of the latency times is set to satisfy the relationship of T1<T2< . . . <T7, and each terminal is allotted the time slot of the basic cycle P2 and synchronizes with each other by means of the heart beat, therefore consideration is given in order to realize smooth communication control, even when transition timings of plural slave stations are conflicting with each other.

If a plurality of master stations exist on the same channel, that would cause a problem for the system control. Accordingly, it is necessary to design the system so that only one master station would automatically be set among the terminals using the same channel. As shown in FIG. 3, in this embodiment, the master station alternately repeats master transmission M2 to send the control message M1 and slave reception S2 for carrier-sensing to check whether or not another terminal operates as the master station on the same channel. When there is another terminal operating as the master station, the terminal which has operated as the master station makes the transition to the slave station in order to keep only one master station on the same channel. Moreover, the master station can stop the master transmission M2 if necessary.

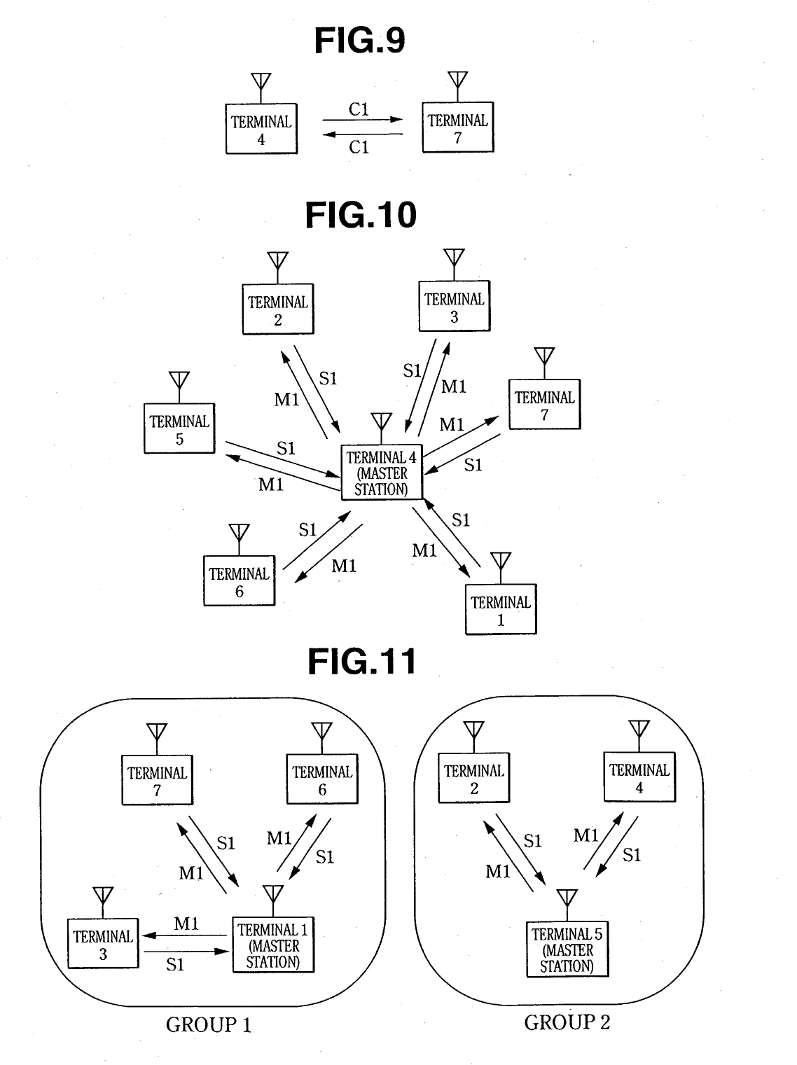

In the above embodiment, the case in which a fixed number of terminals constitutes the communication system has been described. However, without limitation to such a structure, it is possible to freely change the combination of terminals that constitute the communication system. FIG. 9 illustrates the state in which terminal 4 and terminal 7 communicate with each other on a peer-to-peer basis of balanced procedure class, by sending and receiving a signal C1. Other terminals which are not shown in this drawing are in the standby mode. The transition sequence will be described below, in which terminal 4 as the master station conducts the communication control with, not only terminal 7, but also with the other terminals in the standby mode as shown in FIG. 10.

FIG. 5 illustrates the transition sequence of terminal 4 to the master station. While terminal 4 communicates with terminal 7 on a peer-to-peer basis, no master station is selected. If terminal 4 sends the transition request REQ 1 to terminal 7 at a certain time, terminal 7 sends the permission signal ANS1 to other terminals including terminal 4. These other terminals receiving the permission signal ANS1 can become aware in advance that terminal 4 will become a master station. After receiving the permission signal ANS1 from terminal 7, terminal 4 makes the transition to the master station. Depending on the wireless environment, it is possible that terminal 4 may not receive the permission signal ANS1. In order to deal with such a situation, terminal 4 also makes the transition to the master station after timeout period T8 has elapsed without receiving the permission signal ANS1. Meanwhile, terminal 7 makes the transition to the slave station when the period T9 has elapsed since sending the permission signal ANS1.

When terminal 4 becomes a new master station in accordance with the above transition sequence, the master station sends the control message M1 to other terminals and each terminal receiving the control message M1 sends the response message S1 to the master station, thereby completing the transition sequence. FIG. 10 illustrates the state in which terminal 4 as a master station controls the communication with other terminals.

According to the present invention, it is possible to set plural master stations by using different channels. Referring to FIG. 11, terminal 1 belonging to group 1, operates as a master station and controls the terminals 3, 7 and 6 by using channel CH1, which terminal 5 belonging to group 2 operates as a master station, and controls terminals 2 and 4 by using channel CH2. Moreover, a single master station can also function as a master station (a virtual station) for plural groups at the same time. In FIG. 11, for example, terminal 1 can operate as a master station (virtual master station 1) in group 1 by using channel CH1, which it can also operate as a master station (virtual master station 2) in group 2 by using channel CH3. In this case, terminal 5 functions as the master station in group 2 and at the same time it operates as the slave station of terminal 1.

According to this embodiment, each of the terminals that constitute a communication system can voluntarily become the master station at any time so that the system can be flexibly changed as appropriate. Even when a request for transition to a master station conflicts with another transition request, a simple protocol is used to enable smooth transition to a master station, thereby facilitating the system design. Moreover, system stabilization is ensured so that the master station repeats the master transmission and the slave reception in order to keep only one master station among the terminals using the same channel. When plural terminals respectively need to control communication with different terminals at the same time, complicated communication control can be realized in a simple system structure by setting plural virtual master stations. Moreover, because it is unnecessary to control the system by means of high bit rate communication using multislots, it is possible to control the system while ensuring good communication quality.

As described above, it is clear that the communication system of the present invention can provide a very versatile system by means of a simple protocol, as compared with the conventional system in which the master station is previously fixed.

Furthermore, in the embodiment of the present invention, the communication system formed by plural wireless terminals such as digital transceivers, has been described as an example. However, without being limited to this example, the present invention is applicable to other communication systems, for example, a wireless network such as wireless LAN, and a communication system using, as terminals, household electrical appliances with data communication functions such as video cassette recorders, audio systems, TV monitors, and personal computers.

For example, it is possible to freely conduct the system design for the transfer of audio data from an audio system to a personal computer, or the transfer of video data from a video cassette recorder to a TV monitor and a personal computer. While household electrical appliances have their individually independent functions and roles, they can expand their functions by, for example, transferring data to other household electric appliances by means of communication control as necessary. In this respect, these household electrical appliances are especially very convenient because each of them can become the master station and control the system.

According to the present invention, each of the terminals that constitute the communication system can become a master station at any time, thereby making it possible to flexibly change the system as necessary. Accordingly, it is possible to realize complicated system control by using a simple protocol and, therefore, it is possible to realize a highly versatile system.

What is claimed is:

1. A communication terminal, by switching from one mode to the other, operating in either master station operating mode for communicating with a plurality of slave stations that constitute a communication system, and also for controlling the communication system, or slave station operating mode for operating as a slave station in response to a control message from a master station,
the communication terminal comprising:
a transition request means for informing the master station of a transition request for its transition from the slave station to the master station, when it becomes necessary to operate as the master station while it is operating in the slave station operating mode; and
a mode switching means for making the transition from the slave station operating mode to the master station operating mode upon receiving a transition permission signal from the master station.

2. The communication terminal according to claim 1, wherein the terminal in the master station operating mode can select any communication terminal as the slave station.

3. The communication terminal according to claim 1, wherein said mode switching means automatically switches from the slave station operating mode to the master station operating mode when receiving no transition permission signal from the master station, even after a prescribed period of time has elapsed since informing the master station of the transition request.

4. The communication terminal according to claim 1, wherein the communication terminal in the master station operating mode, performs carrier sensing to check at predetermined times, whether or not another master station exists on the same channel, and if it detects the existence of another master station, it makes the transition to the slave station.

5. A communication terminal, by switching from one mode to the other, operating in either master station operating mode for communicating with a plurality of slave stations that constitute a communication system, and also for controlling the communication system, or slave station operating mode for operating as a slave station in response to a control message from a master station,
the communication terminal comprising:
a permission signal sending means for sending a permission signal to another communication terminal when operating in the master station operating mode, and receiving from another communication terminal a transition request for making the transition from the slave station to the master station; and
a mode switching means for making the transition from the master station operating mode to the slave station operating mode after sending the permission signal.

6. The communication terminal according to any one of claims 1 through 5, operating in standby mode, in which the communication terminal operates neither as the master station nor the slave station when no master station is selected in the communication system.

7. The communication terminal according to claim 6, wherein in the standby mode, system synchronization is established by means of heart beats between the communication terminals that constitute the communication system.

8. The communication terminal according to claim 6, wherein if the communication terminal in the standby mode is to make the transition to the master station, it makes the transition to the master station after carrier-sensing for a predetermined period of time, in order to confirm that there is no master station on the same channel.

9. The communication terminal according to claim 7, wherein if the communication terminal in the standby mode is to make the transition to the master station, it makes the transition to the master station after carrier-sensing for a predetermined period of time, in order to confirm that there is no master station on the same channel.

10. A communication system comprising of a plurality of communication terminals, by switching from one mode to the other, operating in either master station operating mode for communicating with a plurality of slave stations that constitutes the communication system, and also for controlling the communication system, or slave station operating mode for operating as a slave station in response to a control message from a master station,
wherein when the slave station needs to operate as the master station, the slave station operating in the slave station operating mode informs the master station of a transition request for making the transition to the master station, when receiving the transition request, the master station sends out a transition permission signal to permit the transition request for making the transition to the master station, and
the slave station receiving the transition permission signal from the master station, switches from the slave station operating mode to the master station operating mode.

11. A computer program product with a computer program recorded on a computer readable recording medium, wherein the program is designed to cause a communication terminal to switch, as necessary, between master station operating mode for communicating with a plurality of slave stations that constitute a communication system, and also for controlling the communication system, and slave station operating mode for operating as a slave station in response to a control message from a master station,
wherein the computer program is to carry out the steps of:
informing the master station of a transition request for making the transition from the slave station to the master station, when the slave station operating in the slave station operating mode needs to operate as the master station; and
switching from the slave station operating mode to the master station operating mode when receiving a transition permission signal from the master station.

12. A computer program product with a computer program recorded on a computer readable recording medium, wherein the program is designed to cause a communication terminal to switch, as necessary, between master station operating mode for communicating with a plurality of slave stations that constitute a communication system, and also for controlling the communication system, and slave station operating mode for operating as a slave station in response to a control message from a master station,
wherein the computer program is to carry out the steps of:
sending a permission signal to another communication terminal, when the communication terminal operating in the master station operating mode receives from another communication terminal, a transition request for making the transition to the master station; and
switching from the master station operating mode to the slave station operating mode after sending the permission signal.
